(19) United States
(12) Patent Application Publication
(10) Pub. No.: US 2005/0207040 A1
(43) Pub. Date: Sep. 22, 2005

(54) Automotive rear view mirror assembly

(76) Inventors: Jason Gao, Rose Valley, PA (US); David Albert Gao, Rose Valley, PA (US)

Correspondence Address: Jason Gao, 2 Buttonwood Way, Rose Valley, PA, 19063, US

(21) Appl. No.: 10/803,270

(22) Filed: Mar. 19, 2004

(51) Int. Cl. G02B 5/08; G02B 7/182

(52) U.S. Cl. 359/860; 359/857

(57) ABSTRACT

A rear view mirror assembly for use internally in sedans, minivans, sport utility vehicles (SUVs), and other vehicles with a rear window to provide an improved view of the field below the rear window. The improved rear view enhances the safety of moving the vehicles backward or towing a trailer. The rear view mirror assembly consists of a convex mirror and a flat mirror, both located near the rear window. The convex mirror is mounted near the top of the rear window, facing the field below the rear window, while the flat mirror is mounted below the convex mirror to reflect the image of field below the rear window to the driver. The driver can view the image in the flat mirror directly while moving backward or through the regular main rear view mirror. The angles of the convex mirror and the flat mirror can be adjusted manually or electronically to meet the needs of different drivers.

### BACKGROUND OF THE INVENTION

The present invention is relates to an internal rear view mirror assembly for sedans, minivans, sport utility vehicles (SUVs), and other vehicles with a rear window to provide the driver an improved rear vision. A provisional application was filed on Mar. 17, 2003 (U.S. PTO 60/454622)

While many drivers find the convenience of modern passenger vehicles, especially minivans and sport utility vehicles (SUVs), they also have concerns regarding the limited rear view due to the sizes of these vehicles. When moving the vehicle backward, the driver usually faces the uncertainty of any objects below the rear window which are also invisible from the side rear view mirror.

The importance of rear view in a vehicle has long been recognized, as reflected by the number of patents in this area, such as U.S. Pat. Nos. 5,107,375; 3,954,328; 4,451,021; 5,559,640; 5,245,479 and references therein. However, most of the efforts were concentrated on the modification of the side rear view mirror or the main rear view mirror by addition of a small mirror or a prism to improve the rear view (U.S. Pat. No. 5,245,479 and reference therein). In addition, there are patents teaching the extension of the side rear view mirror (U.S. Pat. No. 4,451,021) as well as additional mirror mounted outside of the vehicle to improve the rear view (U.S. Pat. No. 5,559,640). However, the modifications to the standard side rear view mirror or the main rear view mirror cannot cover the field below the rear window. The additional external mirrors are generally undesirable in passenger vehicles due to the space it occupied, its effect on aerodynamics, and its applicability under limiting weather condition.

It is thus highly desirable to have a simple internally mounted mirror assembly to improved the rear view of a passenger vehicle, especially the field below the rear window.

### SUMMARY OF THE INVENTION

The present invention is an internal automotive rear view mirror assembly comprising a mirror, including but not limited to a convex mirror, mounted near the top of the rear window and a mirror, including but not limited to a flat mirror, mounted below the first mirror. The top mirror is adjusted to face the external area below the rear window, while the lower mirror is adjusted to reflect the view of the top mirror to the driver. The driver can view the image in the flat mirror directly while moving backward or through the regular main rear view mirror near the driver seat. This rear view mirror assembly is suitable for modern passenger vehicles including sedans, sports wagons, minivans, and Sport Utility Vehicles (SUVs).

### BRIEF DESCRIPTION OF THE DRAWINGS

FIG. 1 is a side view of the regular rear vision of a driver in a sedan.

FIG. 2 is a side view of the improved rear vision of a driver with the rear view mirror assembly in a sedan.

FIG. 3 is a side view of the regular rear vision of a driver in a minivan or a Sport Utility Vehicle (SUV).

FIG. 4 is a side view of the improved rear view of a driver with the rear view mirror assembly in a minivan or a Sport Utility Vehicle (SUV).

### DETAILED DESCRIPTION OF THE INVENTION

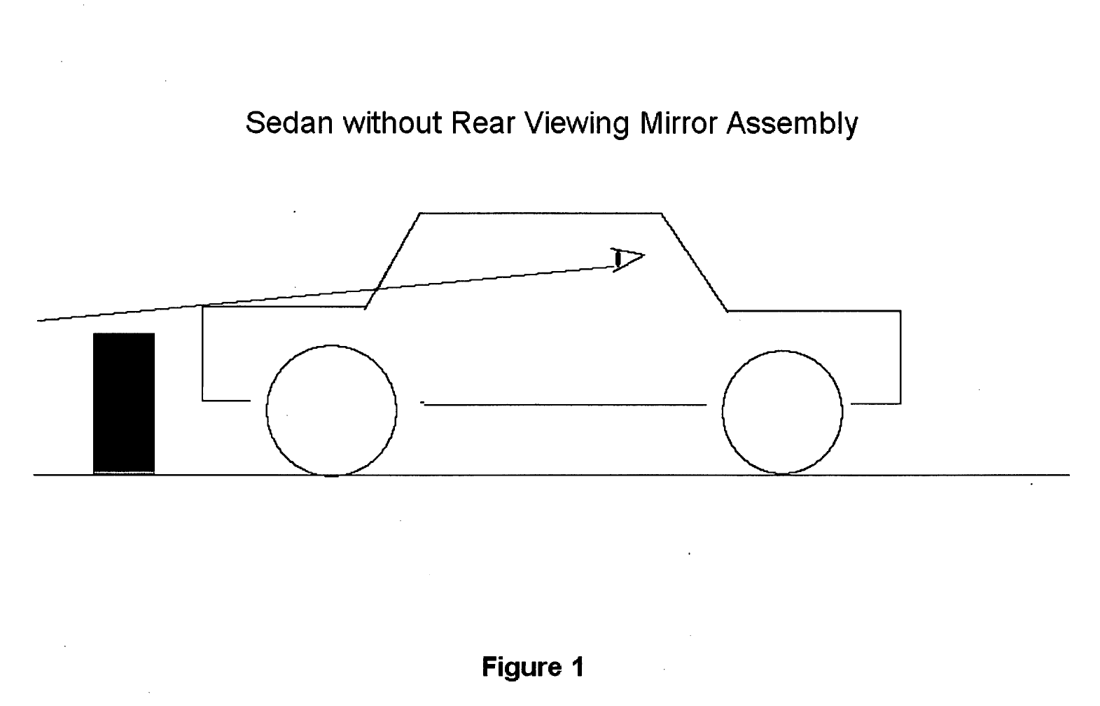

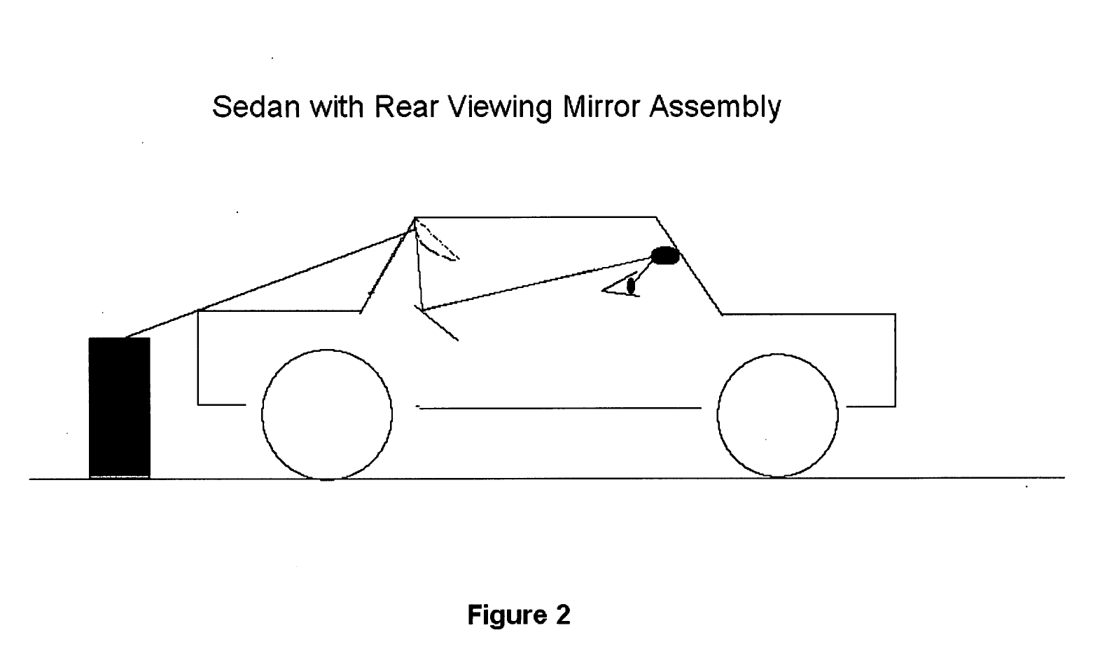

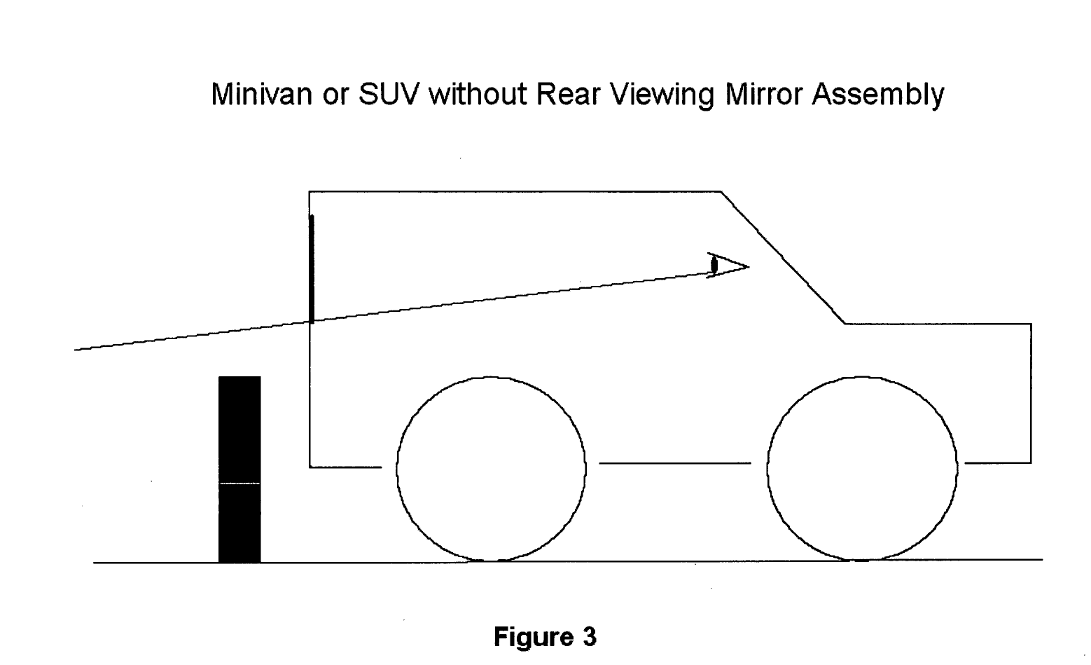

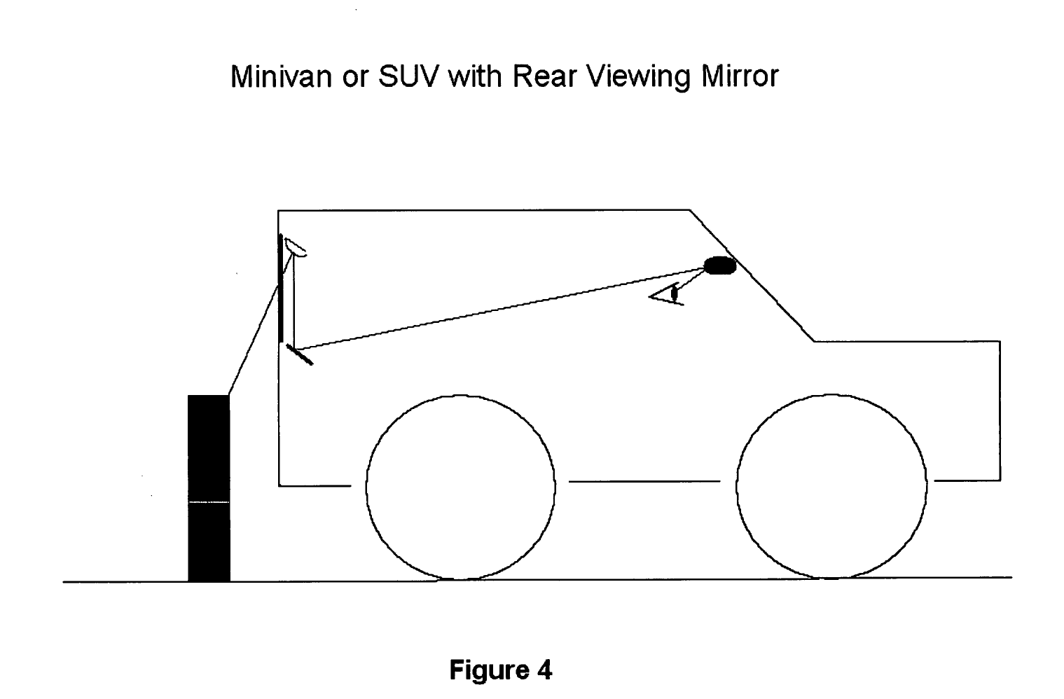

The present invention is for the purpose of improving the rear view of the driver while moving the vehicle backward or towing a trailer. As illustrated in FIG. 1, the vision of the driver in a typical sedan is limited by the size of the window and the size of the luggage compartment, and the position of the driver. When a convex mirror is mounted near the top of the rear window, facing the field below the rear window (beyond the trunk) and a flat mirror is mounted below the convex mirror to reflect the image to the driver, the vision of the driver is significantly improved. The driver can also obtain the improved rear view via the regular main rear view mirror, as shown in FIG. 2. The benefits of the rear view mirror assembly can also be demonstrated in FIGS. 3 and 4 for minivans and Sport Utility Vehicles (SUVs). It is expected that the improvement in driver's rear vision is more significant for minivans and Sport Utility Vehicles (SUVs) due to the height of the rear window and the absence of the trunk.

The preferred shape of the convex mirror in this assembly is circular or oval. It can also be truncated to fit the space available. There is no limit on the shape of the flat mirror; it can be circular, oval, or rectangular. The rear view mirror assembly can be mounted to the vehicles during the manufacturing process or retrofitted to existing vehicles. The angles of the convex mirror and the flat mirror can be adjusted manually or electronically to suit the needs to different drivers.

1. A combination of a two-mirror assembly mounted internally near the rear window in a vehicle to reflect the field below the rear window to the driver's regular main rear view mirror.

2. A combination of internal mirror assembly according to claim 1, wherein said the first mirror is mounted near the top of the rear window, facing the field below the rear window, and the second mirror is mounted near the bottom of the rear window to reflect the image from the first mirror to the driver's regular main rear view mirror.

3. A combination of internal mirror assembly according to claim 1, wherein said the first mirror is a convex mirror mounted near the top of the rear window and the second mirror is a flat mirror mounted near the bottom of the rear window to reflect the image from the convex mirror to the driver's regular main rear view mirror.
